(19) United States
(12) Patent Application Publication
(10) Pub. No.: US 2009/0280861 A1
(43) Pub. Date: Nov. 12, 2009

(54) Multifunctional all-in-one detachable wrist wireless mobile communication device

(75) Inventor: Ashana Sabana Nisha Khan, Hayward, CA (US)

Correspondence Address: ASHANA S. N. KHAN, 25043 PLUM TREE ST, HAYWARD, CA, 94544, US

(73) Assignee: Ashana Sabana Nisha Khan, Hayward, CA (US)

(21) Appl. No.: 12/151,607

(22) Filed: May 9, 2008

(51) Int. Cl. H04M 1/00

(52) U.S. Cl. 455/556.1

(57) ABSTRACT

The invention claimed herein is a Multifunctional, All-in-one, Detachable Wrist Wireless Mobile Communication Device, which can be worn on the wrist, and used with a wireless earpiece for wireless communication needs. This device has a screen and/or buttons to operate the device, is detachable from its base if needed to be used like a regular mobile phone. This multifunctional device has all the mobile communication functions/features/capabilities such as audio, video, camera, media playback, secured wireless (or with an option to plug in) media/data storage capability, secured video/audio house/business/child monitoring features, dual solar charging and AC/DC/car charging capabilities, speaker phone capabilities, and GPS and satellite reception capabilities. All the features mentioned above and described in the specifications eliminates the need to carry a separate MP3 player, or headphones, or flash drive, as all this features are built in this device. By wearing this device, the user does not need to carry a separate mobile device that falls and gets damaged, or is lost or stolen or forgotten in cars and at home, and neither does the user need to locate the device in purses, pockets, or retrieve from holders to answer calls like most mobile phones in the market today. The device also comes with an option to be detached and hanged around the neck with the hanging device claimed herein, if preferred over wearing it on the wrist. It is a convenient, practical, all-in-one, next generation communication device that is readily available on the wrist to use, and thus is the all in one solution for all the communication/media/technology needs of today, and tomorrow.

### BACKGROUND OF THE INVENTION

The Multifunctional All-in-one Detachable Wrist Mobile Communication Device claimed herein pertains to the mobile telecommunications and technologies field.

The existing mobile communication devices have specific problems that can be solved by the invention claimed herein. The existing mobile communication devices are portable and thus tend to fall and get damaged, or get misplaced, lost, stolen, or forgotten. Since these existing mobile communication devices are stored in purses or pockets or in cellular phone holders attached to the waist, it requires substantial amount of time to locate the device, and/or open it, and answer an incoming call. This process of locating the device causes stress on the user as the time to answer an incoming call is limited, before the answering machine goes on. Also, the existing mobile communication devices are an additional device to carry. Furthermore, due to so many accidents/deaths caused by using cell phones while driving, the new California law prohibits a driver from talking on the cell phone while driving, unless a Bluetooth activated earpiece is used. Despite the law, not everyone owns an earpiece while driving, but the invention claimed herein will encourage all drivers to own a Bluetooth activated earpiece.

In addition, there is no such technology in the market that has secured video/audio child monitoring device/features that allows parents to physically view and communicate with their kids from their mobile phones while they are away from them. Neither is there any technology that allows to track kids of their geographical location, from parents mobile phones, if they are abducted to kidnapped or lost. Nor is there any technical feature in any communication device that allows an owner to view secured frontal, rear, or inside views of home or business in their mobile phones for security purposes.

Also, the existing mobile communication devices have to be charged often through AC/DC power for continuous use.

Separate devices have to be carried by users such as an MP3 player, a flash drive, a mobile phone, and /or headphones and earpieces for different communication/media needs.

Lastly, there is no such technology in the market that would allow one to locate car or house keys when misplaced, from their mobile phones.

The new invention, the Multifunctional All-in-one Detachable Wireless Wrist Mobile Communication Device, claimed herein solves all of the problems mentioned above.

### BRIEF SUMMARY OF INVENTION

The invention claimed herein is a Multifunctional All-in-one Detachable Mobile Communication Device that operates with a compatible wireless earpiece, and that has network, satellite, GPS, audio, video, camera, and Internet capabilities, with wireless (or plug-in) data/media storage capabilities, secured video/camera/audio house/business/child monitoring capabilities, with beeper-key locating capabilities, with solar charging capabilities, or any additional capabilities that could be added from existing mobile communication devices. The invention claimed herein can be used with an earpiece for incoming or outgoing calls, or can be detached from the base by a press of a button when needed. The invention claimed herein may also come in different variations for kids, and teenagers, with satellite activated child monitoring feature described in the claims, to locate and monitor kids, with screen and all mobile communications features present in the market today. It may also come with or without a beeper that can be attached to keys and when a button is pressed on the device, the beeper can be activated to locate the keys, and the button on the beeper can locate device when in detached mode.

The invention claimed herein solves many of the problems that exist in the existing mobile communication devices mentioned earlier. Once the device is worn on the wrist, it can be used with wirelessly activated earpiece for incoming and outgoing calls, or to listen to media/sounds. Since the device is attached to the wrist, it does not fall and get damaged, misplaced, lost, or stolen. One does not have to locate the phone since it is readily available and visible on the wrist, thus eliminating the stress and time of locating the device. Since this device is worn on the wrist, and has time displaying on the screen, it eliminates the need to carry an additional device—the watch and cell phone are combined as one device. This new device will also discourage use of mobile phones while driving, and encourage users to own Bluetooth activated earpieces while driving, thus decreasing the rate of fatalities caused by driving while talking on the mobile phone, and abide by the new California Law to use earpieces to talk while driving.

The new child monitoring feature will allow to parents to keep in touch with their kids, view their kids through camera when they are away, or have video communication with them. The satellite activated child monitoring feature in the wrist/watch mobile communication device for kids will allow parents to view, locate, and communicate with their kids if they are lost, abducted, or in a natural disaster such as an earthquake, conveniently and securely through their mobile phones. This device claimed herein also can be lifesaving for older people during medical emergencies as it is readily available on their wrists to quickly call for help. The secured house-monitoring feature in this device will also be the first in the market where owners can securely view their residences and business in the device claimed herein, through installed video cameras (or through satellite) for security purposes. This device also has wireless media playback, audio and video capabilities, where one can listen to any media through the wireless earpiece. This device will also have capabilities to play video or games or any other media. It also has a slot for plugging headphones if needed. The device claimed herein also comes with media/data storage capabilities either securely and wirelessly, or by plugging in the device in the slot (as shown in FIG. 6) that could be retractable, or have any possible variation, but the concept of having the storage capabilities in the phone is claimed herein, where the need to carry an extra flash drive device will be eliminated. The dual solar/AC/DC charging capabilities of this device will allow solar charging of battery when exposed to sunlight, such as when driving, thus allowing continuous battery charging.

The invention claimed herein together with the features mentioned in the “Detail Description of the Invention” and claims, will be the next generation all-in-one mobile communication device that will be practical, convenient, and safe, and will come with features that is needed but is not present in the market yet.

### BRIEF DESCRIPTION OF THE SEVERAL VIEWS OF THE DRAWING

FIG. 1 shows the general view of the Multifunctional All-in-one Detachable Wrist Mobile Communication Device. The placement/position of buttons/keys/slots/screen is preferable, but is not limited in any way. The design shown can have other variations/additions/deletions.

FIG. 2 shows a close-up top view of the top of the device claimed herein. The screen can show/have any possible combination of menu options/features. The buttons/keys shown are preferable but not limited to any other variation/addition/deletion. The view shown makes the device easy to use, and compact, but other possible variations are possible. The 2 positions shown in the Figure are two optional positions to put the video/camera lense. If the video/camera lense is put on the top of the device, it would be easy to take pictures just by turning the hand/wrist, while if the camera/video lense is put one the side of the device (as shown), video conversation and views would be easier and more comfortable. Also, the presence of both the dual lenses is possible too to allow variety of views/functions.

FIG. 3 shows the detached view of the device. It also shows the 2 buttons of both sides of the base that are pressed to release the two clips that attach to the top, thus releasing the top device from the base attached to the wrist band. It also shows that the base attached to the wrist band and the base of the detached piece are both made of material that shields electromagnetic rays/waves, and is heat absorbent.

FIG. 4 shows the view of the beeper attached to the keyring/keychain as claimed in the specifications. One of the buttons shown has the ability to stop the beeping on the beeper, while the other button has the capability to beep the mobile device to locate it.

FIG. 5A shows the view of the device being worn on the top of the wrist.

FIG. 5B shows the mobile device worn at the back of the wrist, where if the video/camera lense is placed on the top of the device, video conversation and views would be easier and comfortable as user does not have to turn the hand/wrist too much.

FIG. 6 shows the neck hanging device that has a clip that attaches the top of the mobile device when in detached mode. This neck hanging device could be used to hang the mobile device if preferred over wearing on wrist, and could also be used to hand other devices.

FIG. 7 shows the right side view of the device. It shows the retractable media/data storage plug in slot that could be retracted out of the device by moving the button to the right or left, and thus can be put back in the device by moving the button back. This feature of retracting the plug in slot is preferable, but other methods could be used to connect the device to any other device to download media/data, including wirelessly or though wires.

FIG. 8A shows an optional/possible design of the device/invention claimed in the specifications, and could have any variations/additions/deletions. The design shown is a top flip open style, where the top can be flip opened to show the screen and buttons inside the device, as shown in FIG. 8A. This design can have any combination of variation, or placement of screen/buttons/keys. The screen could have touch screen capabilities too. When in closed mode, the top of the device could have solar charging screen/capabilities. It has all/as many features as described in detail in “Detail Description of the Invention”.

FIG. 8B shows an optional/possible design of device/invention in general. This design can have any possible variations/deletions/additions. This design has the possibility to either slide the top of the device to the top, or side(s) to reveal the inside of the device with buttons/keys. The screen could have touch screen capabilities too. This design also has all/as many features/capabilities as claimed/described in the specifications section of this invention.

FIG. 8C shows an optional/possible design of the device/invention, in general, and could have any possible variations/additions/deletions. This figure shows the view of the device with the whole top as the screen, with touch screen capability, and solar charging capability. It has all other features shown in the figure, as well as all/as many features/capabilities described in detail in the specifications section of the invention.

FIG. 8D shows an optional/possible design of the device/invention, in general. This design could have any possible variation/addition/deletions. This FIG. 8D shows the elongated/larger to design of the invention, where the top is an elongated design. This design has all/as many features/capabilities described in detail in the specification section of the invention.

### DETAILED DESCRIPTION OF THE INVENTION

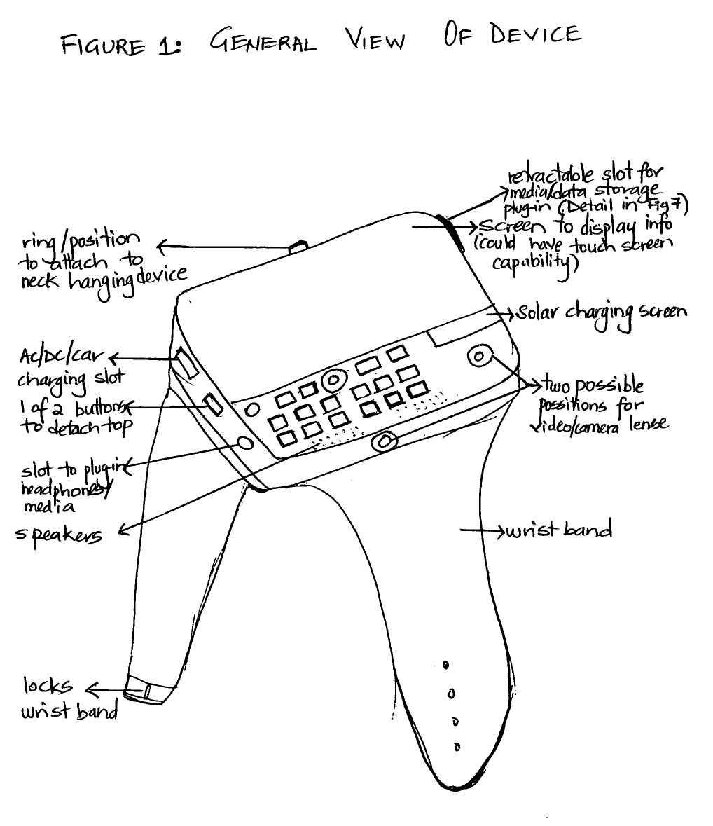

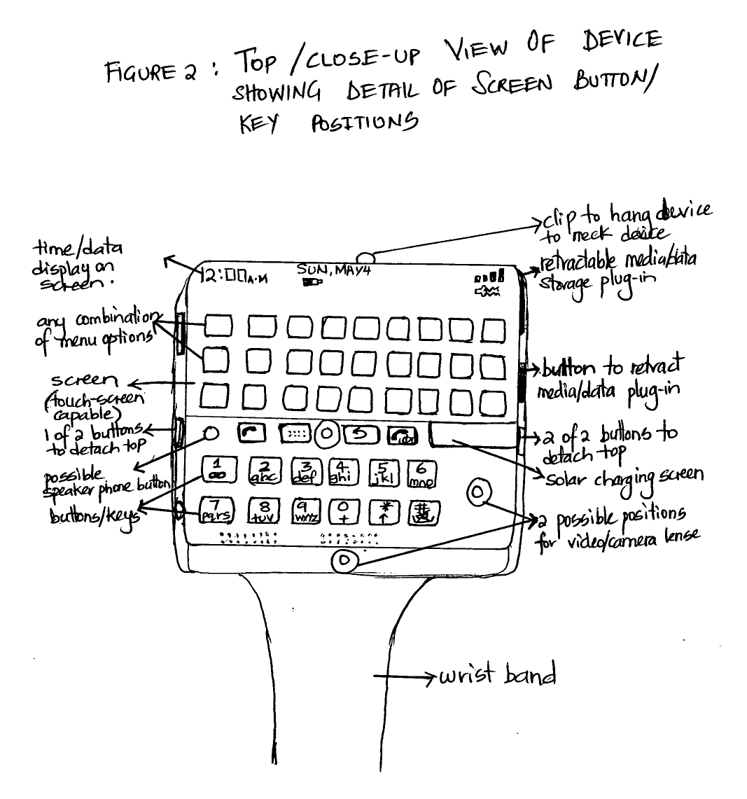

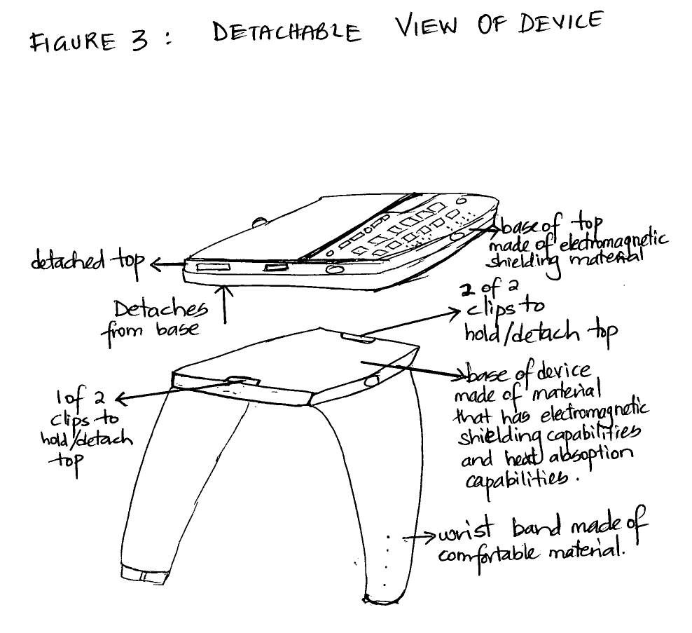

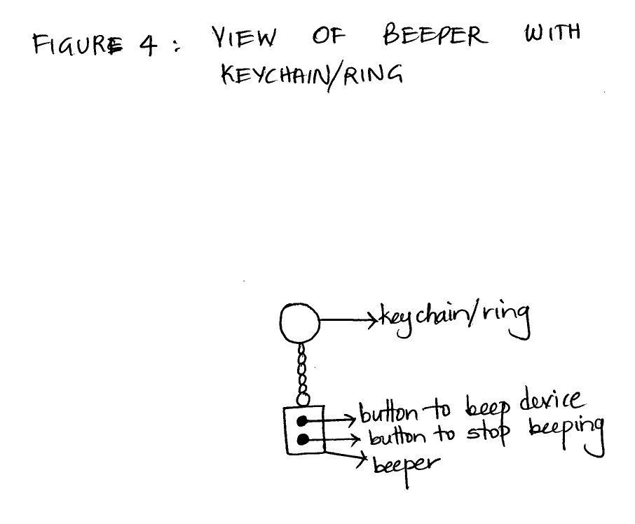

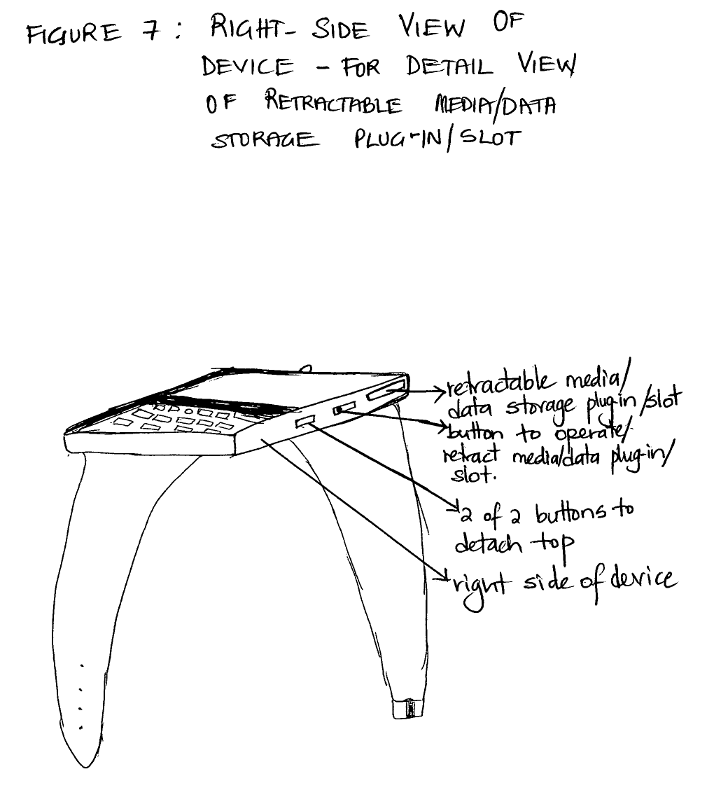

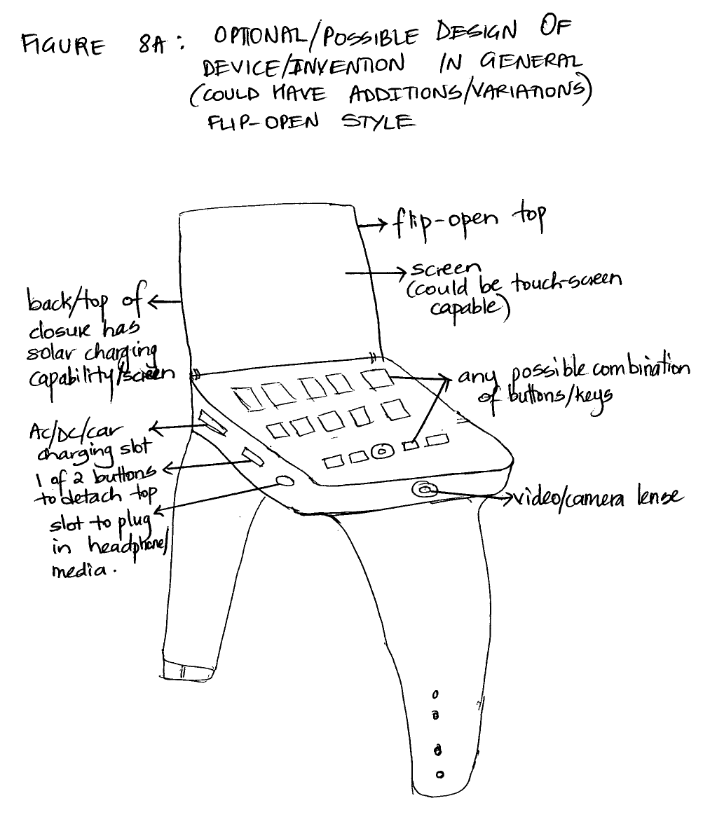

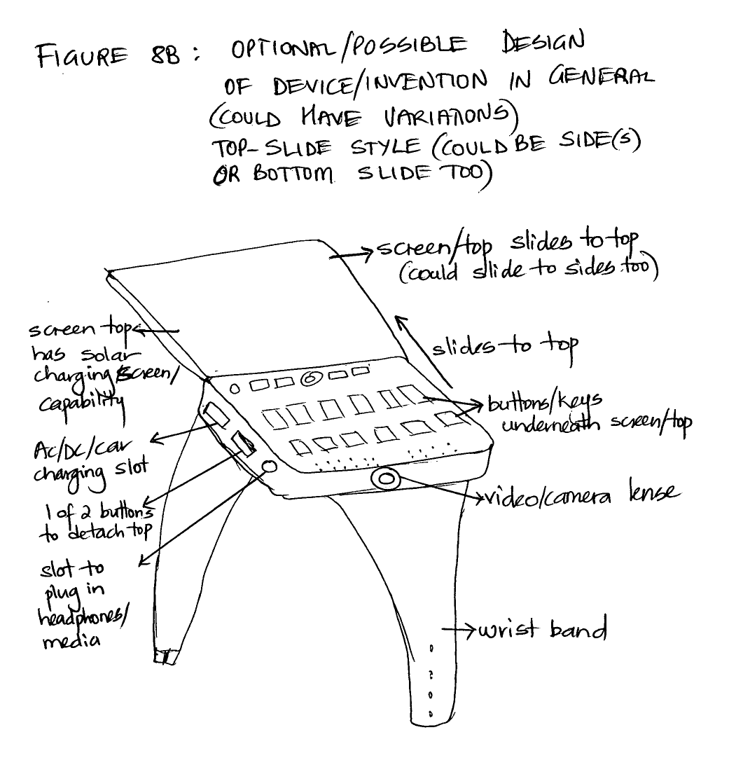

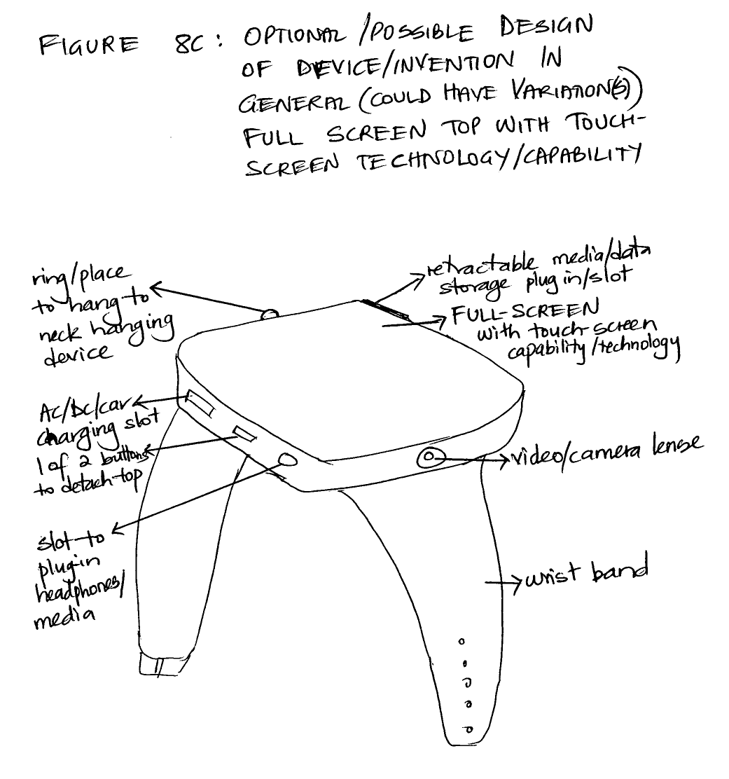

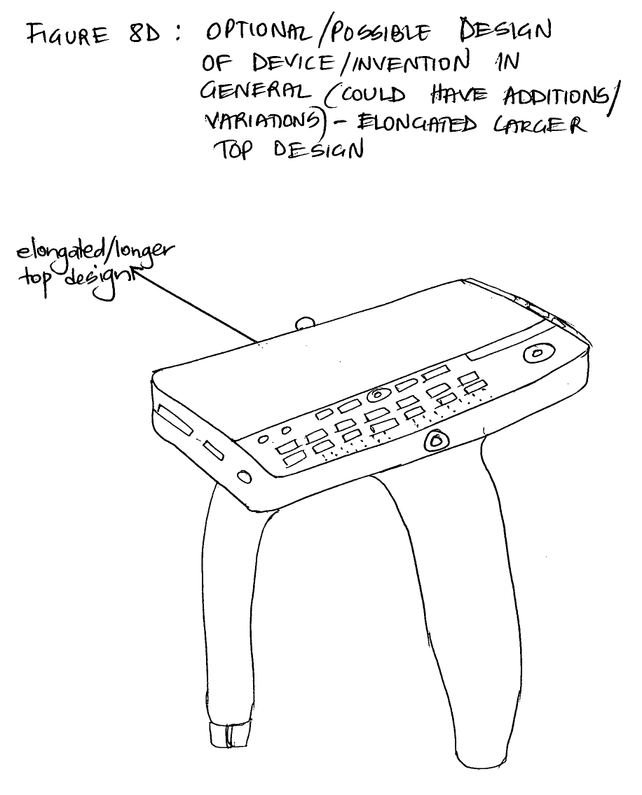

The invention claimed herein is a Multifunctional All-in-one Detachable Wrist Mobile Communication device with network and satellite capability, and that has the following capabilities/features:
1. Can be worn on the wrist like a watch but the top of the watch will have a screen and buttons like a mobile communication device, and will have the capabilities to perform all/as many functions of any mobile phone, together with all the new features claimed herein. The top part of this device is detachable from its base (as shown in FIG. 3) so that it can be used as a regular mobile phone when needed (such as for typing, texting, or for using without earpiece) as shown in FIG. 1. The top view of this device will look like one of a regular mobile phone; a screen and numeric/alphabetic/alphanumeric keys, and/or other keys present in regular phones, together with additional features/keys shown in FIG. 1. The screen on this device can display any or all of the features such as time, date, day, battery, sound, network bars, earpiece symbol, options, menus, (as shown in FIG. 2), or any other features that are displayable on the screen. The screen could also have touch screen capabilities. The device can have any combinations of buttons arranged in any way on the surface of the device for answering calls, or accessing menus or internet, or any other feature. A set of buttons can be placed on each sides of the device top (or anywhere on the device) as shown in FIG. 1, and when this button is pressed, it detaches the mobile communication device from its base that is attached to the wrist, as shown in FIG. 3. The top, detachable mobile device can have any shape, style (such as slide open, or closable), color, design, features, size(larger/smaller top than shown in FIG. 1) or any variation not mentioned herein, and some possible variations are shown in FIG. 8A, FIG. 8B, FIG. 8C, and FIG. 8D The concept of having a fully functional, satellite and GPS capable, mobile communication device (with screen and/or buttons/keys), with mobile network, touch screen capability, Internet, audio/video, media playback, wireless connection, and media/data storage capabilities on a detachable wrist/watch band which has wireless capabilities to connect to a compatible earpiece, together with the other claimed features, is being claimed as the invention. This device claimed herein will always be attached to the wrist, eliminating the need to locate it in purses, or from waist holders, or from pockets, and will also be eliminate the time needed to answer calls as it readily available on the wrist. The device will not drop, get damaged or misplaced or lost or stolen, or forgotten at home or in the car or work, like all the other mobile phones in the market today. The device will also eliminate the need to carry additional devices such as cell phones, MP3 players, headphones, and flash drives. It's an all in one watch that is multifunctional, convenient and practical.
2. The claimed device has wireless connection capabilities, network and satellite connection capability, and can come with a compatible wireless connection enabled earpiece, or made compatible with existing earpieces. A special button may or may not be placed on the top on the device(or selected from menu options) to conveniently activate/connect to earpiece.
3. The claimed device has dual solar/AC/DC charging capabilities for continuous battery charging when sunlight is present. It has a solar recharging screen (as shown in FIG. 1) that can be placed anywhere on the device. The screen will have capabilities of charging the battery of the device through solar power when sunlight is present. This feature claimed herein will continuously increase battery life, and will eliminate frequent recharging of battery.
4. The device claimed herein will have a slot on the left side of the device (or can be placed anywhere on the device) that will allow AC/DC/car charging capabilities(FIG. 1).
5. The device claimed herein will also have audio/video capabilities for media and games, where the audio can be heard on the earpiece wirelessly, or headphones can be plugged in slots (FIG. 1) if needed. The video can be viewable on the screen of the device. These capabilities will eliminate the need to carry an additional MP3 device, and will also eliminate the need for messy wires, or additional headpiece, if wireless connection to the earpiece is used, and will also allow the hands of the user to be free. The slots to plug in headphones can be placed on the left side of the device as shown in FIG. 1, or anywhere on the device, to allow headphones (or other plug and play or media devices) to be plugged in if needed.
6. The device claimed herein also comes in sizes, shapes, designs, and characters for kids and teenagers. This device will be always attached to the child's hand and hence, the child does not drop, lose, or forget it like most mobile phones available to kids in the common market for emergency purposes. It has the child monitoring feature claimed herein, where the parent can automatically activate video/audio in child's device, through their device, without child pressing anything, to physically view and communicate with the child, when they are away from the child. The claimed device will have the capability to securely (by either entering password or any other secure method) activate the video camera/audio on the child's device, and view video images (and sound) on their device of the image viewable on the camera on the child's device. The device claimed herein has camera capabilities, and the camera is located on the top of the device(or can be placed on the side of the top of the device, as shown in FIG. 1 (or can be placed anywhere on the device). This device designed for kids or teenagers, also has camera placed either on the top of the device or anywhere on the device, and has the option to be automatically controlled by the parent device, or the automatic camera/video/audio activation through parent device feature disabled when not needed. This feature will allow parents to keep in touch with their kids, have video communication/conversation/contact with their kids, know/view if the physical environment of the child is safe, locate their child through GPS, if the child is lost, abducted, or kidnapped, or locate/view/contact/communicate with their kids during natural disasters such as earthquakes, tornados, or floods. It will be the next generation feature that will allow parents to have video communication with their kids and feel like they are physically with them, when they are at work or away.
7. The device claimed herein, also has house/business monitoring feature claimed herein. A video camera claimed herein will be compatible with the Multifunctional All-in-one Detachable Wrist Mobile Communication Device and can be placed at any physical location of the residence or business. The mobile device claimed herein will be able to view images through the video camera on their mobile devices, either through satellite, or any other technique. This feature will be secured, and only the mobile device that is securely programmed (with any possible way) with the camera will be able to view/access the images. This feature can be secured by either entering passcodes in the mobile device to acquire access, or any possible security feature, or way. The owner can mount the camera in places such as facing the garage to see if the garage is closed or not when the owner has driven away, hence not having to drive back to the residence to check the garage. It can also be placed in the kitchens, viewing the stoves, where the owner can check if the stove is off or not, not owner is away. The camera can also be placed in front or back of houses or business, so that the owner can view from their watch/wrist detachable mobile devices if their properties are safe from burglary and fires.
8. The invention claimed herein has speaker phone capabilities, that can be activated by the press of a button or selecting the feature from the menu. This feature will allow drivers to talk on the speaker phone while driving, with both their hands free if earpiece is not used, and thus make driving safer.
9. The device claimed herein also has built in media/data storage capabilities such as those in portable flash drives. The device claimed herein can securely and wirelessly connect/download data/media to/from any computer/laptop/device. This device has a retractable slot (as shown in FIG. 7) to plug in to the USB drive of any computer through a wire (designed to be compatible with the device, and to be sold together or separately, with the device). The space or amount of data storage capabilities can vary.
10. The device claimed herein, both the adult or child device, can be worn as either the top of the device on the top of the wrist, or as the top of the device at the bottom of the wrist, where the camera could be facing the user hence allowing comfortable video conversation, and view.
11. The device claimed herein has a base made that can be made of material that has electromagnetic shielding capabilities (as shown in FIG. 2). The top base that is attached to the wrist/watch can be made of material that shields possible electromagnetic rays or waves from the wrist that the device is attached to. This base that is attached to the wristband also can be made of material that absorbs heat or is heat resistant, so that the heat produced from the device is shielded, and does not penetrate to the wrist.
12. The device claimed herein also comes with a beeper claimed herein. This beeper, as shown in FIG. 3, can be attached to the keys or any other device/object, and has the ability to be located with wireless connection technology from the Wrist Mobile device claimed herein. The Wrist Mobile device will have the feature/capability claimed herein, where a button(or selection from a menu of features) can be pressed to activate the beeper (within a certain distance as allowable by the wireless connection capability) and beep, thus locating the misplaced/lost keys or objects that the beeper is attached to. One of the two buttons located on the portable beeper can be pressed to stop the beeping sound on the beeper once it is located. The other button on the beeper can be pressed to locate the mobile device, when the mobile device is in detached mode. Pressing this button will activate a beep or sound on the mobile device, and the beeping sound on the mobile device can be stopped by either pressing a button or choosing a selection from a menu. The concept of locating the object/mobile device through the use of a beeper is claimed herein, and thus any variation of any form is claimed too, and is possible. The beeper can either come with a keyring/keychain (as shown in FIG. 4) or any other style/form so that it can be attached to keys and objects.
13. The device claimed herein also has/should have a physical weight that is comfortable for the user to wear. The size, shape, material, and material of wristband should be comfortable for the user to wear for longer periods.
14. The device claimed herein also has/should have rings, ringtones, beeps, vibrations, or any sounds, or physical alertness capabilities which are mild, moderate, and not in any way shocking to the user who is wearing it.
15. The invention claimed herein may come with a compatible neck hanging device as shown in FIG. 6 to hang the mobile device on the neck when in detached mode. The hanging device can be of any material, color, variation, style, and/or character, and has a ability to click/attach to the available slot/space/ring on the mobile device. The mobile device can be worn on the neck when not preferred to be worn on the wrist.
16. The name of the wrist/watch detachable communication device is claimed to be ” A Phone”, but can also have other names too. The mobile device claimed herein can preferably have the name “A Phone” but is not limited to have different or other names/logos.

1. The invention that is being claimed is the concept of a Multifunctional Detachable Wrist Mobile Communication Device with network and satellite capability, as shown in FIG. 1, and that is worn on the wrist as a watch, and that has a fully functional/multifunctional, detachable mobile communication device as the top which has a screen and/or buttons, and/or which can have any combination of buttons, touch screen capability, other possible variations, style, form, feature, size, color, brand, character, and/or capabilities not shown/mentioned herein, and is described in detail in the “Detail Description of the Invention”, and “Specifications”, and that may have all/some features of a regular mobile phone in the market, together with all/some features claimed herein.

2. Claim 1 has the capability to operate with a wireless compatible earpiece device through wireless connection, for communication and media needs, as described in detail in the “Detail Description of the Invention”.

3. Claim 1 can be detached from its base to use if needed, by the press of a button as shown in FIG. 1, or by any other technique not mentioned herein, as described further in the “Detail Description of the Invention”.

4. Speakers on claim 1 can be activated for communication/media needs when earpiece not used, as described further in “Detail Description of the Invention”.

5. Claim 1 has solar battery charging capabilities together with dual AC/DC/car charging capabilities, as described in details in “Detail Description of Invention”.

6. Claim 1 has the feature claimed herein as the capability to wirelessly play media/music/audio on the compatible, wirelessly connected earpiece, as described in detail in “Detail Description of the Invention”, and where this feature is independently claimed.

7. Claim 1 has the feature claimed independently herein as the audio/video child monitoring feature as described in detail in “Detail Description of the Invention”, that can be automatically activated from the claimed device, either by using satellite, GPS, or any feature/technique.

8. Claim 1 has the feature claimed independently herein as the audio/video house/business monitoring feature as described in detail in “Detail Description of the Invention”, and which can access/manipulate video/camera/audio from/to video/camera installed on premises (house or business) or through satellite.

9. Claim 1 designed for kids/teenagers, can come as a set with parent device, or sold separately, and can come in any shape, size, color, character, brand, or any variation not mentioned herein, and have all/as many features as claim 1 as described in “Detail Description of the Invention”.

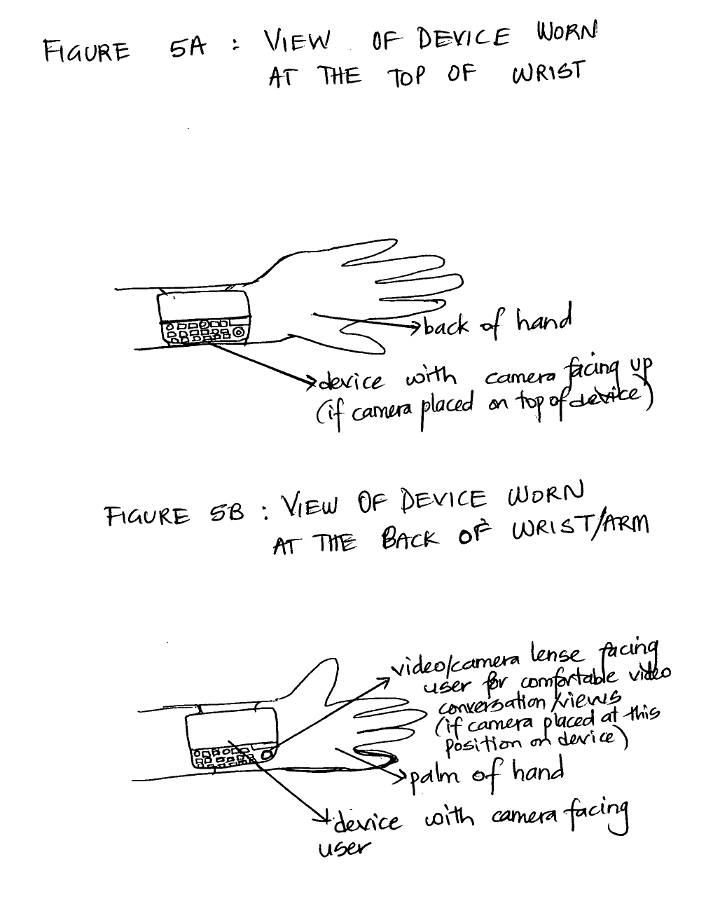

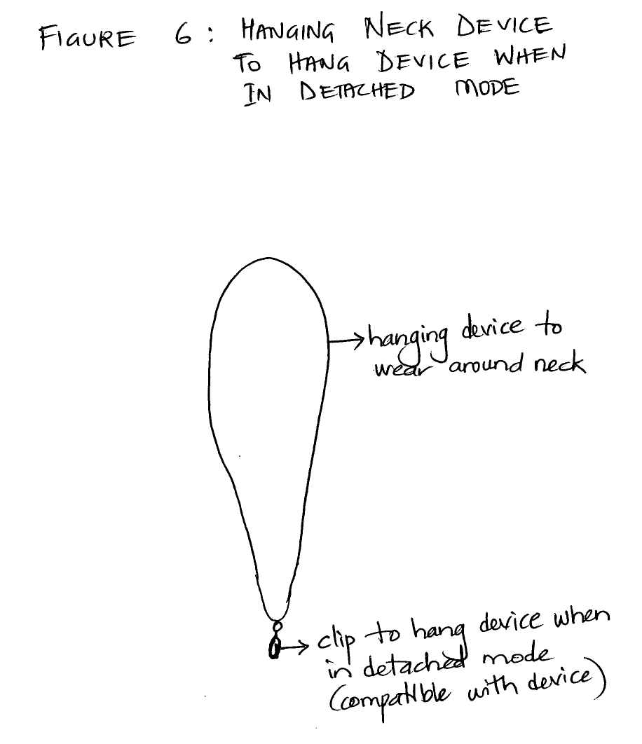

10. Claim one can be hanged on the neck using a compatible hanging device, as shown in FIG. 5, and described in detail in “Detail Description of the Invention”, and can come in any design, material, color, or variation not mentioned herein.

11. Claim 1 has a slot for plugging in headphones or other media devices as shown in FIG. 1, as described further in “Detail Description of the Invention”.

12. Claim 1 has built in secured wireless media/data storage/downloading capabilities claimed independently herein, where media/data can be downloaded to/from claim 1 (or any other device) securely and wirelessly, and/or also by plugging in claim 1 directly(or through wire) to any device through slot shown in FIG. 6(which could be retractable), and as described in detail in “Detail Description of Invention”.

13. Claim 1 has a camera on the top the device for video communication and audio/video needs as shown in FIG. 1, and the camera/audio can be securely and automatically activated in the child's device through parent's device (where camera/audio could be disabled in child's device if preferred) as described in detail in “Detail Description of Invention”.

14. Claim 1 could have separate buttons on the device that could have individual functions such as one special button to activate speakers, or one special button to activate/deactivate earpiece, or one special button to operate camera or audio, or any possible variation not mentioned herein, as described in detail in “Detail Description of the Invention”.

15. The top view of claim 1 has a screen that shows time, date, network availability or bars, graphics, colors, sound, messages, or any other possible information, and beneath this screen is a combination of numeric/alphanumeric keys/buttons (as shown in FIG. 1) to dial/type/select or turn power on/off, and/or carry out any other function, and could have any possible variation of where or how the keys/buttons are located on the device, or have any other additional buttons for additional functions not mentioned herein, as described in detail in “Detail Description of the Invention”.

16. The base of the detachable top piece of claim 1 as well as the base attached to the wristband (as shown in FIG. 2) is/could be made of material that has electromagnetic shielding capabilities, and that can shield all electromagnetic rays/waves to penetrate to the wrist, as described in more detail in “Detail Description of the Invention”.

17. Claim 1 also comes with a beeper, claimed independently herein, and beeping capabilities, and/or wireless technology, (as shown in FIG. 3) where the beeper can be attached to keys/objects, and either by selecting an option on the device or by pressing a button, the beeper attached to the key/objects beeps to identify its location when lost/misplaced, and similarly a button on the beeper could be pressed to locate claim 1 when in detached mode, as described in detail in “Detail Description of the Invention”.

18. Claim 1 has mild moderate ringtones, rings, vibrations, sounds, audio, or any sounds, or physical alertness capabilities which are not in any way shocking to the user, whether wearing it on the wrist, or neck, or using in detached mode, as described further in “Detail Description of the Invention”.

19. The name of claim 1 is claimed to be “A Phone”, but in no way is limited to the name, and is not limited to have different but approved name or logo.

20. Claim 1 may/may not have all/some/any the features of a regular mobile phone in the market today, including features to make and receive calls, internet, texting capabilities, audio/video/game/media/GPS, together with all/any features claimed in the specification or “Detail Description of the Invention” of this invention to make it a multifunctional, all in one mobile device of the next generation.
